(19) United States
(12) Patent Application Publication
(10) Pub. No.: US 2025/0180726 A1
(43) Pub. Date: Jun. 5, 2025

(54) Device and Method for Monitoring and Early Warning Low-power-consumption landslide collapse based on time division multiplexing

(71) Applicants: Cathay Safety Technology Co., Ltd., Beijing (CN); China Academy of Safety Science and Technology, Chaoyang District (CN)

(72) Inventors: Xiaolin YANG, Beijing (CN); Haitao MA, Beijing (CN); Zhengxing YU, Beijing (CN); Guiwen REN, Beijing (CN); Hao ZHANG, Beijing (CN); Shanshan HOU, Beijing (CN)

(73) Assignees: Cathay Safety Technology Co., Ltd., Beijing (CN); China Academy of Safety Science and Technology, Beijing (CN)

(21) Appl. No.: 18/964,328

(22) Filed: Nov. 29, 2024

(30) Foreign Application Priority Data
Dec. 1, 2023 (CN) 202311633820.X

(51) Int. Cl. G01S 13/50; G08B 21/10

(52) U.S. Cl. CPC G01S 13/50; G08B 21/10

(57) ABSTRACT

The present application relates to a device and method for monitoring and early warning Low-power-consumption landslide collapse based on time division multiplexing, comprises: a camera equipment is configured to obtain monitoring images; a RF front-end is configured to transmit and receive radar signals; an intelligent sleep equipment is configured to set sleep time and power down the equipment(s) connected to it to put into sleep mode when the device requires working in a low power consumption mode; a signal processing equipment is configured to realize interference measurement and Doppler detection in a time division multiplexing manner and generate early warning or forecast information; a 5G equipment and an Ethernet port are configured to send the measurement results and monitoring images to a mobile terminal or host computer. The present application realizes the joint work of Doppler detection and interference measurement within one radar device through adaptive time division multiplexing.

### CROSS-REFERENCE TO RELATED APPLICATIONS

This application claims priority to Chinese Patent Application No. 202311633820.X, filed on Dec. 1, 2023, the disclosure of which is hereby incorporated by reference in its entirety.

### BACKGROUND

Geological disasters have occurred frequently in recent years, disasters such as landslides, collapses, mudslides and so on are prone to occur especially in mountainous area, which posed a great threat to the safety of people's lives and property, so it is urgent to carry out monitoring and early warning of landslide collapse disaster. Ground based synthetic aperture radar system has a long monitoring distance and wide coverage area, its monitoring accuracy can reach sub millimetre level. It is able to realize continuous monitoring of key areas and real-time data processing to provide monitoring and early warning, that has significant advantages in monitoring terrain deformation.

The traditional ground based synthetic aperture radar monitoring technology mainly deals with landslides of the slow creep type and the medium speed range (deformation rate is meter level per day), it is difficult to capture the moment of occurrence of landslides and collapses, as well as the phenomena such as mudslides and rocks falling from mountains and slopes, and so on. Therefore, after the occurrence of landslides and collapses, it cannot capture the trajectory of landslides and collapses of the area in real time, and cannot continue make post event forecast for them. Moreover, the traditional slope radar mostly uses separated RF devices, which consumes very large power during working, is not applicable to geologic hazard potential sites without power supply in the field.

### SUMMARY

The present application relates to the technical field of geological disaster monitoring, and particularly relates to a device and method for monitoring and early warning Low-power-consumption landslide collapse based on time division multiplexing.

In view of the above analysis, the embodiment of the present application aims at providing a device and method for monitoring and early warning Low-power-consumption landslide collapse based on time division multiplexing to solve the problems that the existing landslide collapse monitoring methods are difficult to capture the trajectory of landslides and collapses in real time after their occurrence, and are unable to make post event forecast. Moreover, the existing landslide collapse monitoring devices have high power consumption.

Specifically, the present application provides the following technical solution.

In one aspect, the present application provides a device for monitoring and early warning low-power-consumption landslide collapse based on time division multiplexing, the device comprises: a RF front-end, a signal processing equipment, a 5G equipment;
the RF front-end is configured to transmit a radar signal and send the received radar echo signals to the signal processing equipment;
the signal processing equipment comprises a multicore DSP, the multicore DSP comprises a time division multiplexing scheduling unit, an interference measurement equipment, a Doppler detection equipment; the time division multiplexing scheduling unit is configured to perform scheduling switching between the interference measurement equipment and the Doppler detection equipment by setting mode switching time and realize interference measurement and Doppler detection in a time division multiplexing manner; the interference measurement equipment and the Doppler detection equipment are configured to realize interference measurement and Doppler detection based on the received radar echo signals respectively; the multicore DSP generates early warning information or forecast information of landslide collapse based on results of the interference measurement or the Doppler detection, and sends the results of the interference measurement and the Doppler detection, the early warning information or forecast information of landslide collapse to the 5G equipment;
the 5G equipment is configured to send the results of the interference measurement and the Doppler detection as well as the early warning information or the forecast information of landslide collapse to mobile terminals.

Further, the device also comprises: an intelligent sleep equipment, a camera equipment;
the intelligent sleep equipment is configured to connect to the camera equipment, the RF front-end and the signal processing equipment respectively, and set up a separate power electronic switch for each equipment connected to it, the intelligent sleep equipment is configured to receive the results of the interference measurement from the signal processing equipment, set the sleep time according to judgment of low power consumption requirement as well as the results of the interference measurement, and power down one or more equipment(s) connected to it to put them into sleep mode when the device requires working in low power consumption mode;
the camera equipment is configured to obtain surveillance images of a monitoring area and send the surveillance images to the signal processing equipment.

Further, the signal processing equipment also comprises a FPGA unit, an AD data acquisition unit;
the AD data acquisition unit is configured to perform data acquisition of the radar echo signals sent by the RF front-end and send them to the FPGA unit;
the FPGA unit is configured to preprocess the collected radar echo signals and send them to the multicore DSP, receive the results of the interference measurement from the multicore DSP and send them to the intelligent sleep equipment; the FPGA unit is further configured to send the received surveillance images of the monitoring area to the 5G equipment.

Further, the Doppler detection equipment comprises: a distance FFT unit, a Doppler FFT unit, a CFAR detection unit; the interference measurement equipment comprises: a radar imaging unit, an interferogram unit, a phase unwrapping unit;
wherein the distance FFT unit is configured to perform fast Fourier transform on the preprocessed radar echo signals to convert time domain signals into frequency domain signals, extract a peak value of the frequency domain signals to calculate the distance to the target; the Doppler FFT unit is configured to perform Doppler FFT based on the radar echo signals output from the distance FFT unit to extract the Doppler frequency shift information of the target to calculate the speed of the target; the CFAR detection unit is configured to output the results of the Doppler detection and set a landslide collapse forecast threshold adaptively to reduce the probability of false forecast;
the radar imaging unit is configured to calculate the distance to the target based on the preprocessed radar echo signals, map the spatial position information of the target onto a two-dimensional radar image according to the distance to the target; the interferogram unit is configured to receive the radar image data output from the radar imaging unit, and generate an interferogram based on the two sets of radar image data received at adjacent time points; the phase unwrapping unit is configured to restore the wrapped phase in the interferogram to the real continuous phase, and output the results of the interference measurement.

Further, the device also comprises an Ethernet port;
the Ethernet port is configured to receive the results of the interference measurement and the Doppler detection as well as the on-site surveillance images from the multicore DSP, and upload them to a host computer.

Further, the intelligent sleep equipment judges whether the device has low power consumption requirement, a judgment criterion of the low power consumption requirement judgment comprises an installation location, a charging current, battery power of the device;
when the device requires working in low power consumption mode, the intelligent sleep equipment is configured to set the sleep time based on the results of the interference measurement, and powers down power electronic switch of one or more corresponding equipment(s) via clock gating to put them into the sleep mode; when the results of the interference measurement are incoherence, then the sleep time is set to 0;
when the device does not require working in low power consumption mode, then the sleep time is set to 0, that is, the equipment(s) do not enter into the sleep mode.

Further, the time division multiplexing scheduling unit is configured to scheduling switching between the interference measurement equipment and the Doppler detection equipment by the following method:
judging the deformation stages of the slope deformation data monitored by the interference measurement according to a classical landslide curve, switching between the interference measurement and the Doppler detection in accordance with a preset fixed time when the slope deformation data is in a stage of uniform deformation; subtracting the preset reduction value from the preset fixed time to obtain the updated fixed time, switching between the interference measurement and the Doppler detection in accordance with the updated fixed time to increase the frequency of interference measurement for capturing the displacement deformation of mountains when the slope deformation data is in a stage of accelerated deformation; increasing the preset fixed time by the preset increase value to obtain the updated fixed time, switching between the interference measurement and Doppler detection in accordance with the updated fixed time to increase the frequency of Doppler detection for capturing landslides and collapses trajectory when the slope deformation data is in the stage of incoherence.

Further, the generating early warning information or forecast information of landslide collapse based on the results of the interference measurement or Doppler detection comprises:
obtaining the speed, displacement and duration of the slope deformation according to the results of the interference measurement, reaching the landslide collapse warning threshold when the speed, displacement and duration all reach the corresponding thresholds, sending the landslide collapse warning information, and switching to the Doppler detection for real-time monitoring;
obtaining the speed and distance of the target according to the results of the Doppler detection, reaching the landslide collapse forecast threshold when the speed and distance of the target all reach the corresponding thresholds, sending the landslide collapse forecast information;
the warning information comprises marking the warning area with cloud map colors; the forecast information comprises the current position and movement trajectory of the fast-moving targets.

Further, the preprocessing the collected radar echo signals comprises:
configuring the sampling frequency, the number of sampling bits of the AD data acquisition unit;
when performing the interference measurement: performing down-conversion to the collected radar echo signals; performing data extraction or interpolation to the down-converted radar echo signals according to the actual demand; performing gain control to the data extracted or interpolated radar echo signals;
when performing the Doppler detection: mixing the transmitted radar signal and the received radar echo signals; filtering the mixed radar echo signal.

Further, the method comprises the following steps:
S1, setting the mode switching time, entering a Doppler mode for the Doppler detection, and starting the switching time countdown;
S2, when the mode switching time is reached, entering the interference measurement mode for the interference measurement; updating the mode switching time based on the slope deformation data monitored by the interference measurement, switching the interference measurement and Doppler detection modes according to the updated mode switching time;
S3, obtaining the speed, displacement and duration of the slope deformation according to the results of the interference measurement, reaching the “speed-displacement-duration” warning threshold when the speed, displacement and duration all reach the corresponding thresholds, sending the warning information, and switching to the Doppler detection for real-time monitoring;
S4, obtaining the speed and distance of the target according to the results of the Doppler detection, determining the existence of fast-moving targets when the speed and distance of the target all reach the corresponding thresholds, sending the forecast information.

Compared with existing technology, the present application achieves at least one of the following beneficial effects:
1. The present application realizes the joint work of Doppler detection and interference measurement within one set of radar hardware device through adaptive time division multiplexing technology, realizes simultaneous monitoring of small displacement deformation and fast-moving targets through seamless switching of the two working modes, solving the problem that the existing slope radar is difficult to capture the trajectory of landslides and collapses in real time after their occurrence, and is unable to make post event forecast; it can provide pre-warning for possible landslide collapse disaster and make post event forecast after the disaster occurs through real-time monitoring at the geologic hazard potential sites of landslides, collapses, mudslides and so on, reminding the surrounding people to evacuate in time to reduce casualties and property losses.
2. The present application uses highly integrated RF radar chip to replace the traditional separated RF devices, reducing the use of active devices, which not only reduces the power consumption of the device, providing a basis for meeting the long-term monitoring needs of the potential hazardous sites without power supply in the field, but also effectively reduces the size and the cost of the device.
3. The present application modifies the sleep time of the equipment(s) inside the device intelligently according to the slope deformation data, when the slope deformation data is in the stage of uniform deformation, it makes the equipment(s) sleep for a long time, when the slope deformation data is in the stage of accelerated deformation, it shortens the sleep time to increase the frequency of data acquisition, when the slope deformation data is in the stage of incoherence, it no longer sleeps and enters the Doppler detection to perform real-time monitoring; the present application further reduces the power consumption of the device in an intelligent sleep manner, providing a basis for meeting the long-term monitoring needs of the potential hazardous sites without power supply in the field.

In the present application, the above technical solutions can be combined, to implement more preferred combined solutions. Other features and advantages of the present application will be described in the subsequent specification, and part of the advantages can become apparent from the specification, or be understood through the implementation of the present application. The objects and other advantages of the present application can be implemented and obtained from the contents particularly illustrated in the specification and the drawings.

### BRIEF DESCRIPTION OF THE DRAWINGS

In order to more clearly illustrate the technical solutions in the embodiments of the present application or in some implementations, the accompanying drawings to be used in the description of the embodiments or some implementations will be briefly introduced below. Obviously, the accompanying drawings described in the following are only some of the embodiments of the present application. For a person of ordinary skill in the art, other accompanying drawings can be obtained based on these accompanying drawings without any creative effort. The drawings are merely for the purpose of illustrating the particular embodiments, and are not considered as limitation to the present application. Throughout the drawings, the same reference signs denote the same elements.

FIG. 1 is a structure schematic of device for monitoring and early warning the low-power-consumption landslide collapse based on time division multiplexing of embodiment provided by the present application;

FIG. 2 is a flow diagram of the method for monitoring and early warning the low-power-consumption landslide collapse based on time division multiplexing of embodiment provided by the present application; and

FIG. 3 is a flow diagram of time division multiplexing switching of embodiment provided by the present application.

### DETAILED DESCRIPTION

The preferable embodiments of the present application will be particularly described below by referring to the drawings. The drawings form part of the present application, are used to explain the principle of the present application together with the embodiments of the present application, and are not limiting the scope of the present application. It should be clear that the embodiments described are only a portion of the embodiments of the present application and not all of the embodiments. Based on the embodiments of the present application, all other embodiments obtained by a person of ordinary skill in the art without any creative effort fall within the scope of protection of the present application.

The person skilled in the art should know that the following particular embodiments are a series of optimized setting methods listed in the present application for the purpose of further explaining the specific content of the application, these setting methods can be used in combination with or in association with each other, unless it is clearly stated in the present application that some or a certain particular embodiment cannot be set up in association or used in conjunction with other embodiments. At the same time, the following particular embodiments are only optimized setting methods, and are not limiting the scope of protection of the present application.

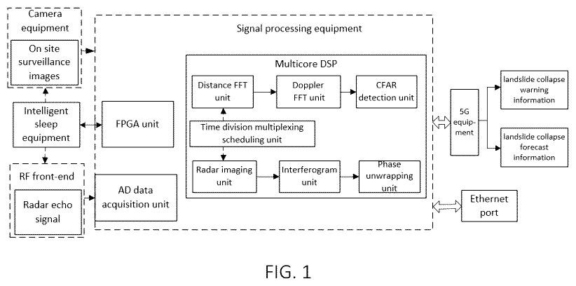

A particular embodiment of the present application discloses a device for monitoring and early warning low-power-consumption landslide collapse based on time division multiplexing, as shown in FIG. 1, the device comprises: a RF front-end, a signal processing equipment, a 5G equipment.

Wherein the RF (Radio Frequency) front-end is configured to transmit a radar signal and send the received radar echo signals to the signal processing equipment.

The signal processing equipment comprises a multicore DSP, the multicore DSP comprises a time division multiplexing scheduling unit, an interference measurement equipment, a Doppler detection equipment; the time division multiplexing scheduling unit is configured to perform scheduling switching between the interference measurement equipment and the Doppler detection equipment by setting mode switching time and realize interference measurement and Doppler detection in a time division multiplexing manner; the interference measurement equipment and the Doppler detection equipment are configured to realize the interference measurement and the Doppler detection based on the received radar echo signals respectively; the multicore DSP generates early warning or forecast information of landslide collapse based on the results of the interference measurement or the Doppler detection, and sends the results of the interference measurement and the Doppler detection, the early warning information or forecast information of landslide collapse to the 5G equipment.

The 5G equipment is configured to send the results of the interference measurement and Doppler detection as well as the early warning or forecast information of landslide collapse to mobile terminals.

Further, the device also comprises: an intelligent sleep equipment, a camera equipment.

The intelligent sleep equipment is connected to the camera equipment, the RF front-end and the signal processing equipment respectively, and set up a separate power electronic switch for each equipment connected to it, the intelligent sleep equipment is configured to receive the results of the interference measurement from the signal processing equipment, set the sleep time according to judgment of low power consumption requirement as well as the results of the interference measurement, and power down one or more equipment(s) connected to it to put them into sleep mode when the device requires working in low power consumption mode.

The camera equipment is configured to obtain surveillance images of a monitoring area and send the surveillance images to the signal processing equipment.

It is to be specified that the signal processing equipment sends the received surveillance images of the monitoring area to the 5G equipment, which in turn are sent by the 5G equipment to mobile terminals.

Further, the device also comprises an Ethernet port, wherein the Ethernet port is configured to receive the results of the interference measurement and Doppler detection as well as the on-site
surveillance images from the multicore DSP, and upload them to the host computer.

Further, the time division multiplexing scheduling unit performs scheduling switching of the interference measurement equipment and the Doppler detection equipment by the following method:
judging the deformation stage of the slope deformation data monitored by the interference measurement according to the classical landslide curve, wherein switching between the interference measurement and Doppler detection in accordance with a preset fixed time, when the slope deformation data is in the stage of uniform deformation; subtracting the preset reduction value from the preset fixed time to obtain the updated fixed time, switching between the interference measurement and Doppler detection in accordance with the updated fixed time to increase the frequency of interference measurement for capturing the displacement deformation of mountains, when the slope deformation data is in the stage of accelerated deformation; increasing the preset fixed time by the preset increase value to obtain the updated fixed time, switching between the interference measurement and Doppler detection in accordance with the updated fixed time to increase the frequency of Doppler detection for capturing landslides and collapses trajectory, when the slope deformation data is in the stage of incoherence.

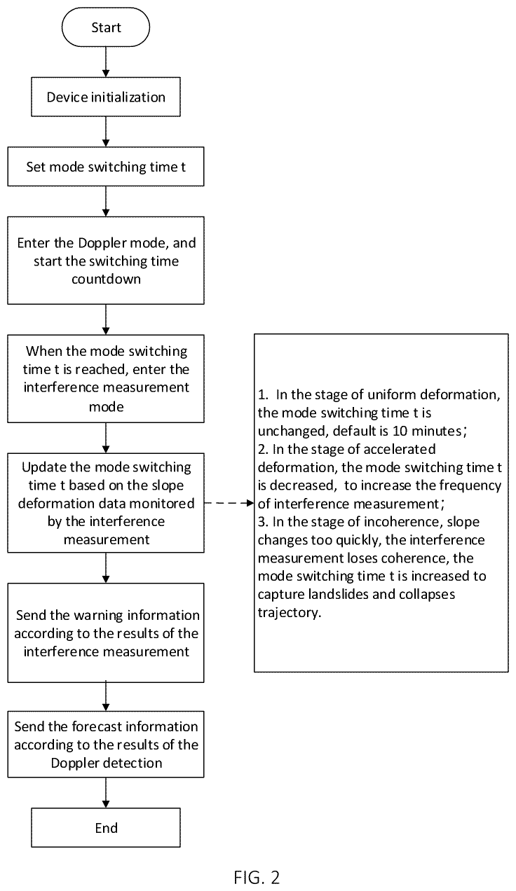

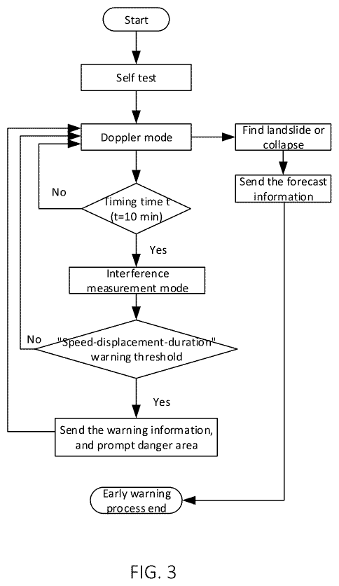

For example, as shown in FIGS. 2 and 3, after the device is started and self-checking, it enters the Doppler detection mode to perform Doppler detection, after working for t time (t=10 minutes), it switches to the interference measurement mode to perform interference measurement, the duration of each interference measurement is less than 3 seconds. When the slope deformation data monitored by the interference measurement is in the stage of uniform deformation, t is unchanged, switching the working mode once every 10 minutes; when the slope deformation data is in the stage of accelerated deformation, t is reduced, e.g. t=5 minutes, switching the working mode once every 5 minutes; when the slope deformation data is in the stage of incoherence, t is increased, e.g. t=120 minutes, switching the working mode once every 120 minutes.

Preferably, when the slope deformation data is in the stage of incoherence, the camera equipment transmits on-site images at fixed time intervals.

It is to be specified that when the slope deformation data is in the stage of incoherence, the updated fixed time can be made very large so that the device can perform the Doppler detection for a longer period of time, thus capturing landslides and collapses trajectory in real time.

Specifically, the intelligent sleep equipment judges whether the device has low power consumption requirement, a judgment criterion of low power consumption requirement comprises an installation location, a charging current, battery power of the device.

When the device requires working in low power consumption mode, the intelligent sleep equipment sets the sleep time based on the results of the interference measurement, and powers down power electronic switch of one or more corresponding equipment(s) via clock gating to put them into sleep mode; when the results of the interference measurement are incoherence, then the sleep time is set to 0.

When the device does not require working in low power consumption mode, then the sleep time is set to 0, that is, the equipment(s) do not enter into sleep mode.

It is to be specified that it starts timing when the equipment enters sleep mode, the corresponding equipment enters working mode when the timing reaches the sleep time, the intelligent sleep equipment resets the sleep time according to the low power consumption requirement judgment and the results of the interference measurement.

For example, assuming that the installation location of the device is a potential site of a field geologic disasters, and there is no electric supply, the lighting conditions is poor. When the monitored battery power is less than 30% and the charging current of the solar energy is less than the discharging current, it is judged that the device needs to work in low power consumption mode. At this time, if the slope deformation data monitored by the interference measurement is in the stage of uniform deformation, then the sleep time is set to 10 minutes, so that makes the camera equipment, the RF front-end and the signal processing equipment all enter the sleep mode; if the slope deformation data monitored by the interference measurement is in the stage of accelerated deformation, then the sleep time is set to 5 minutes, so that makes the camera equipment, the RF front-end and the signal processing equipment all enter the sleep mode; If the slope deformation data monitored by the interference measurement is in the stage of incoherence, the sleep time is set to 0, so that makes the camera equipment, the RF front-end and the signal processing equipment all enter the working mode to monitor the slope deformation data in real time and transmit the on-site images once every 10 minutes.

It should be specified that the deformation data being in the stage of uniform deformation refers to that the slope deformation is small and changes smoothly; the slope deformation data being in the stage of accelerated deformation refers to that the slope deformation rate is constantly and smoothly increasing; the slope deformation data being in the stage of incoherence refers to that the slope deformation rate is sharply increasing and accompanied by sudden changes in displacement.

Understandably, the present application modifies the sleep time of the equipment(s) comprised by the device intelligently according to the slope deformation data, when the slope deformation data is in the stage of uniform deformation, it makes the equipment(s) sleep for a long time; when the slope deformation data is in the stage of accelerated deformation, it shortens the sleep time of the equipment(s) to increase the frequency of data acquisition; when the slope deformation data is in the stage of incoherence, it no longer sleeps and enters the Doppler detection to perform real-time monitoring; the present application further reduces the power consumption of the device through the intelligent sleep, providing a basis for meeting the long-term monitoring needs of the potential hazardous sites without power supply in the field. When the device does not require working in low power consumption mode, all equipments of the device do not enter the sleep mode and perform real-time monitoring throughout the day.

Specifically, the camera equipment obtains video data of the monitoring area and surveillance images based on the video data, to monitor the monitoring site cooperating with the results of the interference measurement and the Doppler detection.

Specifically, the RF front-end comprises a plurality of cascaded monolithic RF radar chips and a plurality of transmitter antenna arrays connected to the monolithic RF radar chips.

For example, the RF front-end is cascaded by 4 monolithic RF radar chips (MMIC), providing 12 transmitting channels and 16 receiving channels, which can be equivalent to 192 virtual array units. Any one of the chips is set as a master chip and the other three chips are set as slave chips; the master chip is configured to generate frequency modulated continuous wave (FMCW) signal as a local oscillator signal of the device through its internal signal synthesizer, and send the local oscillator signal to the other three slave chips; each slave chip performs frequency multiplication on the local oscillator signal to generate the final FMCW signal, thus realizing the signal sharing of the cascaded chips.

Specifically, the final FMCW signal may be represented as:

$${s}_{t} ( t ) = {A}_{t} cos ( 2 π {f}_{c} t + πμ {t}^{2} ) ,$$

where μ is the FM slope, f_{c} is the carrier frequency of the FMCW signal, Aₜ indicates the amplitude of the FMCW signal.

It should be specified that the present application uses highly integrated monolithic RF radar chip instead of separated RF devices, the monolithic RF radar chip internally integrates a voltage-controlled oscillator, a phase locked loop, a power amplifier, a low-noise amplifier, a mixer, a DSP microprocessor. The present application uses highly integrated RF radar chip to replace the traditional separated RF devices, reducing the use of active devices, which not only reduces the power consumption of the device, providing a basis for meeting the long-term monitoring needs of the potential hazardous sites without power supply in the field, but also effectively reduces the volume and the cost of the device.

Understandably, the RF front-end adopts a plurality of MMIC chips cascade design, breaking through the limitation of single chip performance. The design challenges of high inter pulse phase stability and high isolation of the cascaded chips are solved through multilayer board design, reasonable layout of devices, equal length wiring of signal lines, clock synchronization of the cascaded chips, providing a basis for improving the resolution of radar imaging and the accuracy of the interference measurement and Doppler detection.

Further, the signal processing equipment also comprises an FPGA unit, an AD data acquisition unit.

The AD data acquisition unit is configured to perform data acquisition of the radar echo signals sent by the RF front-end and send it to the FPGA unit.

The FPGA unit is configured to preprocess the collected radar echo signals and send them to the multicore DSP, receive the results of the interference measurement from the multicore DSP and send them to the intelligent sleep equipment; the FPGA unit is further configured to send the received on-site surveillance images to the 5G equipment.

Specifically, the preprocessing the collected radar echo signals comprises:
configuring the sampling frequency, the number of sampling bits of the AD data acquisition unit;
when performing the interference measurement: performing down-conversion to the collected radar echo signals; performing data extraction or interpolation to the down-converted radar echo signals according to the actual demand; performing gain control to the data extracted or interpolated radar echo signals;
when performing the Doppler detection: mixing the transmitted radar signal and the received radar echo signals; filtering the mixed radar echo signal.

It is to be specified that the FPGA unit configures parameters such as the sampling frequency and the number of sampling bits of the AD data acquisition unit according to the bandwidth and the required resolution of the radar signals, to ensure that the radar echo signals can be completely acquired. When the RF front-end transmits the radar signal, the FPGA unit sends a trigger signal to the AD data acquisition unit to start data acquisition; the AD data acquisition unit converts the received analog radar echo signals into digital signals and sends it to the FPGA unit, the FPGA unit stores it in an internal cache (e.g., a first-in-first-out cache, FIFO). The FPGA unit removes the high frequency components of the acquired radar echo signals through digital mixing and filtering operations, and only remains the baseband signal containing the target information, thus performing digital down-conversion. The FPGA unit performs extraction or interpolation to the down-converted radar echo signals according to the actual demand: if the sampling frequency is too high, extracts a certain amount of data from the sampled data proportionally to reduce data volume; if it is required to improve the resolution of the radar echo signals, then interpolates the down-converted radar echo signals to increase data volume. The FPGA unit performs automatic gain control to the data extracted or interpolated radar echo signals according to the signal strength, so that its signal strength is in the appropriate range to avoid signal saturation or too weak, in order to improve the accuracy of the subsequent signal processing. The FPGA unit achieves hardware acceleration through parallel computing, the present application realizes real-time processing of a large amount of radar echo data through hardware acceleration, edge computing, multicore DSP parallel computing, improves the data processing speed.

Specifically, the multicore DSP (Digital Signal Processor) has a plurality of processing cores, multiple tasks can be performed simultaneously or large-scale signal processing task can be processed in parallel by integrating the plurality of processing cores into one chip, which is very suitable for the realization of time division multiplexing algorithm between interference measurement and Doppler detection. Understandably, the running speed of the time division multiplexing algorithm can be greatly improved by the multicore parallel processing capability to achieve processing capacity of time division multiplexing algorithm between interference measurement and Doppler detection in real time. The multicore DSP can flexibly allocate tasks and resources according to the monitoring requirements, and dynamically schedule the measurement modes according to the application requirements to achieve higher system performance and efficiency.

Further, the Doppler detection equipment comprises: a distance FFT unit, a Doppler FFT unit, a CFAR detection unit; the interference measurement equipment comprises: a radar imaging unit, an interferogram unit, a phase unwrapping unit.

The distance FFT unit is configured to perform fast Fourier transform (FFT) on the preprocessed radar echo signals, convert the time domain signal into frequency domain signal, extract the peak value of the frequency domain signal to calculate the distance to the target; the Doppler FFT unit is configured to perform Doppler FFT based on the radar echo signals output from the distance FFT unit, extract the target's Doppler frequency shift information to calculate the speed of the target; the CFAR detection unit is configured to output the results of Doppler detection and set a landslide collapse forecast threshold adaptively to reduce the probability of false forecast.

The radar imaging unit is configured to calculate the distance to the target based on the preprocessed radar echo signals, map the spatial position information of the target onto a two-dimensional radar image according to the distance to the target; the interferogram unit is configured to receive the radar image data output from the radar imaging unit, and generate interferogram based on the two sets of radar image data received at adjacent time points; the phase unwrapping unit is configured to restore the wrapped phase in the interferogram to the real continuous phase, and output the results of the interference measurement.

Specifically, the results of Doppler detection comprise distance, speed, trajectory of a fast-moving target; the results of interference measurement comprise speed, displacement, time of slope deformation.

It should be specified that since the detected target may have radial speed, its distance and speed cannot be obtained at the same time by one FFT. Therefore, a second FFT of the radar echo signals output from the distance FFT unit is required to extract the Doppler frequency shift information to obtain the speed of the target.

Specifically, the radar imaging unit maps the preprocessed radar echo signals onto a two-dimensional image, thereby constructing a radar image of the slope, to display shape and deformation of the slope visually.

Specifically, the interferogram unit generates an interferogram by calculating the phase difference between two sets of radar image data received at different times and representing the phase difference information in the form of an image. Understandably, the phase change in the interferogram can reflect the small deformation of the slope, which provides a basis for subsequent phase unwrapping and displacement calculation.

It should be specified that wrapped phase refers to that the phase value can only vary within the range of [−π, π] due to the limitation of numerical representation in phase measurement. Since the phase in the interferogram is wrapped phase within the range of [−π, π], it is required that the phase unwrapping unit unwraps the phase by phase unwrapping algorithms, such as branch-cut, least squares, etc., thus restoring the wrapped phase to the real continuous phase. Understandably, by phase unwrapping, an accurate displacement can be calculated according to the phase-displacement formula, which provides a basis for improving the calculation accuracy of the slope displacement.

Specifically, during the interference measurement, two sets of radar echo signals at different moments are collected and preprocessed to obtain their phase difference and time difference, obtaining the displacement of the slope deformation by the phase difference, obtaining the duration of the slope deformation by the time difference, obtaining the speed of the slope deformation by the displacement and duration of the slope deformation.

Specifically, the displacement of the slope deformation is obtained by the following formula:

$$Δ d = \frac{λΔϕ}{4 π} ,$$

wherein, Δd is the displacement of the slope deformation, Δϕ is the phase difference of the radar echo signals.

Understandably, when the RF front-end transmits a radar signal to the slope to be measured, the radar echo signals reflected back from the slope is received by the RF front-end, when the slope generates slow or small deformation, the phase of the radar echo signals received at different time will produce phase difference.

Specifically, during the Doppler detection, the transmitted signal and the received radar echo signals are collected and preprocessed, performing the first fast Fourier transform on the preprocessed radar echo signals through the distance FFT unit to calculate the distance to the target, performing the second fast Fourier transform on the radar echo signals after the first fast Fourier transform through the Doppler FFT unit to extract the Doppler shift, calculating the speed of the target, obtaining the movement trajectory of the target according to the distance and speed of the target, and detect the fast-moving targets.

It should be specified that since the RF front-end has a plurality of transmitter antennas, it can achieve the measurements of the same target at different angles according to the relative positions of the plurality of transmitter antennas to the target.

Specifically, the distance FFT unit calculates the distance to the target by the following formula:

$$R = \frac{{cf}_{b}}{2 μ} ,$$

wherein, R is the distance to the target, f_{b} is the frequency of the radar echo signals after the first fast Fourier transform.

It should be specified that a series of corresponding f_{b} values are obtained after the first fast Fourier transform, the distance to the target is calculated by extracting the peak value corresponding to f_{b} using the above formula.

Specifically, the Doppler FFT unit calculates the speed of the target by the following formula:

$$v = \frac{{f}_{d} λ}{2} ,$$

wherein, f_{d} is the Doppler shift, ν is the speed of the target, λ is the wavelength of the radar echo signals.

It should be specified that a series of corresponding f_{d} values are obtained after the second fast Fourier transform, the speed of the target is calculated by extracting the peak value corresponding to f_{d} using the above formula.

Specifically, the CFAR detection unit outputs the distance, speed, trajectory of the detected fast-moving target, and sets the landslide collapse forecast threshold adaptively by statistically analyzing the surrounding noise and signal clutter, so as to determine the appropriate landslide collapse forecast threshold according to the actual situation, to reduce the probability of false forecast caused by the interference of the noise and clutter when performing Doppler detection.

It is to be specified that according to the distance of the landslide collapse body, that is the distance to the target, the horizontal and vertical coordinates of the target relative to the radar can be calculated, according to the value of the horizontal and vertical coordinates, the movement trajectory of the monitored collapse body or rolling stone can be displayed in real time in the coordinate system centered around the radar.

Preferably, through the alignment of the radar data and the three-dimensional terrain data, the movement trajectory of the above monitored collapse body or rolling stone is displayed on the three-dimensional terrain in real time, to display the location of the collapse body or rolling stone visually.

Specifically, point cloud image of the monitoring area terrain is obtained through the camera equipment, radar image of the monitoring area terrain is obtained through the radar imaging unit. For each pixel point in the radar image, a matching point in the point cloud image is searched for, which has the same slant distance and azimuth angle as it in the radar image, Add the pixel point and its matching point, so as to project the radar slope deformation data onto the three-dimensional point cloud data to complete the data fusion and realize the projection of slope deformation information onto the point cloud image.

It is to be specified that the camera equipment comprises a three-dimensional scanner, a three-dimensional point cloud image of the terrain can be obtained through the three-dimensional scanner, the point cloud
image comprises distance direction, azimuth angle, elevation information; the radar image is a two-dimensional image of the monitoring area projected onto a slant distance plane, the radar image comprises distance direction, and azimuth angle; by searching for matching points in the point cloud image that have the same slant distance as well as azimuth angle as those in the radar image, and adding the pixel the point and its matching point to realize the alignment of the radar image and the point cloud image.

Further, as shown in FIG. 3, generating early warning information or forecast information of landslide collapse based on the results of the interference measurement or Doppler detection comprises:
obtaining the speed, displacement and duration of the slope deformation according to the results of the interference measurement, reaching the landslide collapse warning threshold when the speed, displacement and duration all reach the corresponding thresholds, sending the landslide collapse warning information, and switching to the Doppler detection for real-time monitoring;
obtaining the speed and distance of the target according to the results of the Doppler detection, reaching the landslide collapse forecast threshold when the speed and distance of the target all reach the corresponding thresholds, determining the existence of fast-moving targets, sending the landslide collapse forecast information.

The warning information comprises marking the warning area with cloud map colors; the forecast information comprises the current position and movement trajectory of the fast-moving targets.

It should be specified that when the landslide collapse warning threshold of “speed-displacement-duration” is reached, the slope deformation data monitored by the interference measurement is in the stage of incoherence, which indicates that there is a high probability of landslide or collapse occurring on the slope, so the landslide collapse warning information is issued in time to inform the surrounding people to get ready for evacuation, and switching to the Doppler mode to capture the fast-moving targets in the warning area in real time and to capture the moment when landslide and collapse occur, so the landslide collapse forecast information is issued in time to inform the surrounding personnel to evacuate.

Understandably, the present application realizes the joint work of Doppler detection and interference measurement within one set of radar hardware device through adaptive time division multiplexing technology, realizes the simultaneous monitoring of small displacement deformation and fast-moving targets through the seamless switching of the two working modes, solving the problem that the existing slope radar is difficult to capture the trajectory of landslides and collapses in real time after their occurrence, and is unable to make post event forecast; it can provide pre-warning for possible landslide collapse disaster and make post event forecast after the disaster occurs through real-time monitoring at the geologic hazard potential sites of landslides, collapses, mudslides and other disasters, reminding the surrounding people to evacuate in time to reduce casualties and property losses. The present application can be used for monitoring slopes of open-pit mines, tailing dams, railway lines and hydropower stations, especially suitable for monitoring mudslide bodies, which can provide the surrounding people sufficient time to evacuate by discovering the potential danger area and warning in advance.

Another particular embodiment of the present application discloses a method for monitoring and early warning the low-power-consumption landslide collapse based on time division multiplexing, as shown in FIG. 2 and FIG. 3, the method comprises the following steps:
S1, setting the mode switching time, entering the Doppler mode for the Doppler detection, and starting the switching time countdown;
S2, when the mode switching time is reached, entering the interference measurement mode for the interference measurement; updating the mode switching time based on the slope deformation data monitored by the interference measurement, switching the interference measurement and Doppler detection modes according to the updated mode switching time;
S3, obtaining the speed, displacement and duration of the slope deformation according to the results of the interference measurement, reaching the “speed-displacement-duration” warning threshold when the speed, displacement and duration all reach the corresponding thresholds, sending the warning information, and switching to the Doppler detection for real-time monitoring;
S4: obtaining the speed and distance of the target according to the results of the Doppler detection, determining the existence of fast-moving targets when the speed and distance of the target all reach the corresponding thresholds, sending the forecast information.

Specifically, the updating the mode switching time based on the slope deformation data monitored by the interference measurement comprises:
judging the deformation stage of the slope deformation data monitored by the interference measurement according to the classical landslide curve, switching between the interference measurement and Doppler detection in accordance with a preset fixed time when the slope deformation data is in the stage of uniform deformation; subtracting the preset reduction value from the preset fixed time to obtain updated fixed time, switching between the interference measurement and Doppler detection in accordance with the updated fixed time to increase the frequency of interference measurement for capturing the displacement deformation of mountains when the slope deformation data is in the stage of accelerated deformation; increasing the preset fixed time by the preset increase value to obtain updated fixed time, switching between the interference measurement and Doppler detection in accordance with the updated fixed time to increase the frequency of Doppler detection for capturing landslides and collapses trajectory when the slope deformation data is in the stage of incoherence.

Compared with existing technology, the beneficial effects of the device and method for Low-power-consumption landslide collapse monitoring and early warning based on time division multiplexing provided by the present application are as following:

1. The present application realizes the joint work of Doppler detection and interference measurement within one set of radar hardware device through adaptive time division multiplexing technology, realizes the simultaneous monitoring of small displacement deformation and fast-moving targets through the seamless switching of the two working modes, solving the problem that the existing slope radar is difficult to capture the trajectory of landslides and collapses in real time after their occurrence, and is unable to make post event forecast; it can provide pre-warning for possible landslide collapse disaster and make post event forecast after the disaster occurs through real-time monitoring site at the geologic hazard potential sites of landslides, collapses, mudslides and other disasters, reminding the surrounding people to evacuate in time to reduce casualties and property losses.

2. The present application uses highly integrated RF radar chip to replace the traditional separated RF devices, reducing the use of active devices, which not only reduces the power consumption of the device, providing a basis for meeting the long-term monitoring needs of the potential hazardous sites without power supply in the field, but also effectively reduces the size and the cost of the device.

3. The present application modifies the sleep time of the equipment(s) inside the device intelligently according to the slope deformation data, when the slope deformation data is in the stage of uniform deformation, it makes the equipment(s) sleep for a long time; when the slope deformation data is in the stage of accelerated deformation, it shortens the sleep time to increase the frequency of data acquisition; when the slope deformation data is in the stage of incoherence, it no longer sleeps and enters the Doppler detection to perform real-time monitoring; the present application further reduces the power consumption of the device through the intelligent sleep method, providing a basis for meeting the long-term monitoring needs of the potential hazardous sites without power supply in the field.

Any process or method in the flowchart or described herein by other ways can be understood to represent equipment, fragment or portion of code comprising one or more executable instructions for implementing the steps of a particular logical function or process, and the scope of the preferred embodiments of the present application includes additional implementations, wherein functions can be performed not in the order shown or discussed, including performing functions in an essentially simultaneous manner or in reverse order according to the functions involved, it should be understood by those skilled in the art to which the embodiments of the present application belongs. The processor performs each method and process described above. For example, the method implementations of the present application can be implemented as software programs which are tangibly contained in a machine-readable medium, such as a memory. In some implementations, some or all of the software program can be loaded and/or installed via a memory and/or a communication interface. When the software program is loaded into the memory and executed by the processor, one or more steps of the method described above can be performed. Alternatively, in other implementations, the processor can be configured to perform one of the methods described above by any other appropriate means (e.g., with the help of firmware).

A person skilled in the art can understand that all or part of the process of implementing the methods of the above embodiments can be implemented by related hardware according to an instruction from a computer program, and the program may be stored in a computer-readable storage medium, wherein the computer-readable storage medium is a magnetic disc, an optical disc, a read-only memory, a random access memory and so on.

The above are merely preferable particular embodiments of the present application, and the protection scope of the present application is not limited thereto. All of the variations or substitutions that a person skilled in the art can easily envisage within the technical scope disclosed by the present application should fall within the protection scope of the present application.

1. A device for monitoring and early warning the low-power-consumption landslide collapse based on time division multiplexing, wherein the device comprises: a RF front-end, a signal processing equipment, a 5G equipment;
wherein the RF front-end is configured to transmit a radar signal and send received radar echo signals to the signal processing equipment;
the signal processing equipment comprises a multicore DSP, the multicore DSP comprises a time division multiplexing scheduling unit, an interference measurement equipment, a Doppler detection equipment; the time division multiplexing scheduling unit is configured to perform scheduling switching between the interference measurement equipment and the Doppler detection equipment by setting mode switching time and realize interference measurement and Doppler detection in a time division multiplexing manner; the interference measurement equipment and the Doppler detection equipment are configured to realize the interference measurement and the Doppler detection based on the received radar echo signals respectively; the multicore DSP generates early warning information or forecast information of landslide collapse based on results of the interference measurement or the Doppler detection, and sends the results of the interference measurement and the Doppler detection, the early warning information or the forecast information of landslide collapse to the 5G equipment;
the 5G equipment is configured to send the results of the interference measurement and the Doppler detection as well as the early warning information or the forecast information of landslide collapse to mobile terminals.

2. The device for monitoring and early warning the low-power-consumption landslide collapse based on time division multiplexing according to claim 1, wherein the device also comprises: an intelligent sleep equipment, a camera equipment;
wherein the intelligent sleep equipment is configured to connect to the camera equipment, the RF front-end and the signal processing equipment respectively, and set up a separate power electronic switch for each equipment connected to it, the intelligent sleep equipment is configured to receive the results of the interference measurement from the signal processing equipment, set sleep time according to judgment of low power consumption requirement as well as the results of the interference measurement, and power down one or more equipment(s) connected to it to put them into sleep mode when the device requires working in low power consumption mode;
the camera equipment is configured to obtain surveillance images of a monitoring area and send the surveillance images to the signal processing equipment.

3. The device for monitoring and early warning the low-power-consumption landslide collapse based on time division multiplexing according to claim 2, wherein the signal processing equipment also comprises a FPGA unit, an AD data acquisition unit;
wherein the AD data acquisition unit is configured to perform data acquisition of the radar echo signals sent by the RF front-end and send them to the FPGA unit;
the FPGA unit is configured to preprocess the collected radar echo signals and send them to the multicore DSP, receive the results of the interference measurement from the multicore DSP and send them to the intelligent sleep equipment; the FPGA unit is further configured to send the received surveillance images of the monitoring area to the 5G equipment.

4. The device for monitoring and early warning the low-power-consumption landslide collapse based on time division multiplexing according to claim 1, wherein the Doppler detection equipment comprises: a distance FFT unit, a Doppler FFT unit, a CFAR detection unit; the interference measurement equipment comprises: a radar imaging unit, an interferogram unit, a phase unwrapping unit;
wherein the distance FFT unit is configured to perform fast Fourier transform on the preprocessed radar echo signals to convert time domain signals into frequency domain signals, extract a peak value of the frequency domain signals to calculate a distance to a target; the Doppler FFT unit is configured to perform Doppler FFT based on the radar echo signals output from the distance FFT unit to extract Doppler frequency shift information of the target to calculate speed of the target; the CFAR detection unit is configured to output results of the Doppler detection and set a landslide collapse forecast threshold adaptively to reduce probability of false forecast;
the radar imaging unit is configured to calculate the distance to the target based on the preprocessed radar echo signals, map the spatial position information of the target onto a two-dimensional radar image according to the distance to the target; the interferogram unit is configured to receive the radar image data output from the radar imaging unit, and generate an interferogram based on the two sets of radar image data received at adjacent time points; the phase unwrapping unit is configured to restore the wrapped phase in the interferogram to real continuous phase, and output the results of the interference measurement.

5. The device for monitoring and early warning the low-power-consumption landslide collapse based on time division multiplexing according to claim 3, wherein the device also comprises an Ethernet port;
the Ethernet port is configured to receive the results of the interference measurement and the Doppler detection as well as the on-site surveillance
images from the multicore DSP, and upload them to a host computer.

6. The device for monitoring and early warning the low-power-consumption landslide collapse based on time division multiplexing according to claim 3, wherein the intelligent sleep equipment judges whether the device has low power consumption requirement, a judgment criterion of the low power consumption requirement comprises an installation location, a charging current, battery power of the device;
when the device requires working in low power consumption mode, the intelligent sleep equipment is configured to set the sleep time based on the results of the interference measurement, and power down power electronic switch of one or more corresponding equipment(s) via clock gating to put them into the sleep mode; when the results of the interference measurement are incoherence, the sleep time is set to 0;
when the device does not require working in low power consumption mode, the sleep time is set to 0, that is, the equipment(s) do not enter into the sleep mode.

7. The device for monitoring and early warning the low-power-consumption landslide collapse based on time division multiplexing according to claim 1, wherein the time division multiplexing scheduling unit is configured to perform scheduling switching between the interference measurement equipment and the Doppler detection equipment by the following method:
judging deformation stages of slope deformation data monitored by the interference measurement according to a classical landslide curve, switching between the interference measurement and the Doppler detection in accordance with a preset fixed time when the slope deformation data is in a stage of uniform deformation; subtracting the preset reduction value from the preset fixed time to obtain the updated fixed time, switching between the interference measurement and the Doppler detection in accordance with the updated fixed time to increase the frequency of interference measurement for capturing the displacement deformation of mountains when the slope deformation data is in a stage of accelerated deformation; increasing the preset fixed time by the preset increase value to obtain the updated fixed time, switching between the interference measurement and Doppler detection in accordance with the updated fixed time to increase the frequency of Doppler detection for capturing landslides and collapses trajectory when the slope deformation data is in a stage of incoherence.

8. The device for monitoring and early warning the low-power-consumption landslide collapse based on time division multiplexing according to claim 1, wherein the multicore DSP generates early warning information or forecast information of landslide collapse based on the results of the interference measurement or Doppler detection comprises:
obtaining the speed, displacement and duration of the slope deformation according to the results of the interference measurement, reaching the landslide collapse warning threshold when the speed, displacement and duration all reach the corresponding thresholds, sending the landslide collapse warning information, and switching to the Doppler detection for real-time monitoring;
obtaining speed and distance of the target according to the results of the Doppler detection, reaching the landslide collapse forecast threshold when the speed and distance of the target all reach the corresponding thresholds, sending the landslide collapse forecast information;
the warning information comprises marking the warning area with cloud map colors; the forecast information comprises the current position and movement trajectory of the fast-moving targets.

9. The device for monitoring and early warning the low-power-consumption landslide collapse based on time division multiplexing according to claim 3, wherein the FPGA unit is configured to preprocess the collected radar echo signals comprises:
configuring the sampling frequency, the number of sampling bits of the AD data acquisition unit;
when performing the interference measurement: performing down-conversion to the collected radar echo signals; performing data extraction or interpolation to the down-converted radar echo signals according to the actual demand; performing gain control to the data extracted or interpolated radar echo signals;
when performing the Doppler detection: mixing the transmitted radar signal and the received radar echo signals; filtering the mixed radar echo signal.

10. A method for monitoring and early warning the low-power-consumption landslide collapse based on time division multiplexing, wherein the method comprises the following steps:
S1, setting the mode switching time, entering a Doppler mode for the Doppler detection, and starting the switching time countdown;
S2, when the mode switching time is reached, entering the interference measurement mode for the interference measurement; updating the mode switching time based on the slope deformation data monitored by the interference measurement, switching the interference measurement and Doppler detection modes according to the updated mode switching time;
S3, obtaining speed, displacement and duration of the slope deformation according to the results of the interference measurement, reaching the “speed-displacement-duration” warning threshold when the speed, displacement and duration all reach the corresponding thresholds, sending the warning information, and switching to the Doppler detection for real-time monitoring;
S4, obtaining the speed and distance of the target according to the results of the Doppler detection, determining the existence of fast-moving targets when the speed and distance of the target all reach the corresponding thresholds, sending the forecast information.
